(19) United States
(12) Patent Application Publication
(10) Pub. No.: US 2011/0275268 A1
(43) Pub. Date: Nov. 10, 2011

(54) NON-WOVEN, SELF-WRAPPING THERMAL SLEEVE AND METHOD OF CONSTRUCTION THEREOF

(76) Inventors: David A. Harris, Coatesville, PA (US); Eric K. Staudt, Reading, PA (US)

(21) Appl. No.: 13/104,508

(22) Filed: May 10, 2011

Related U.S. Application Data
(60) Provisional application No. 61/333,019, filed on May 10, 2010.

(51) Int. Cl. B32B 5/26; B65H 81/06; D04H 13/00

(52) U.S. Cl. 442/319; 442/327; 156/190

(57) ABSTRACT

A self-wrapping, non-woven sleeve for routing and protecting elongate members and method of construction thereof is provided. The sleeve includes an elongate non-woven wall having opposite sides extending along a longitudinal axis of the sleeve. The sides are self-wrapping about the longitudinal axis to provide a tubular cavity. The sides are extendable away from one another under an externally applied force to expose the cavity for insertion of the elongate members, wherein the sides return to their self-wrapped configuration upon removal of the externally applied force. The wall includes discrete first regions of a material and discrete second regions of a material. The first and second regions of material are different and provide the wall with non-uniform physical properties.

### CROSS-REFERENCE TO RELATED APPLICATION

This application claims the benefit of U.S. Provisional Application Ser. No. 61/333,019, filed May 10, 2010, which is incorporated herein by reference in its entirety.

### BACKGROUND OF THE INVENTION

1. Technical Field

This invention relates generally to sleeves for protecting elongate members, and more particularly to non-woven, self-wrapping sleeves and to their method of construction.

2. Related Art

It is known that wires and wire harnesses carried in sleeves in vehicles, such as in automobiles, aircraft or aerospace craft, can be exposed to potentially damaging radiant heat and can produce undesirable noise while the vehicle is in use. The noise typically stems from the wires or harnesses vibrating against the sleeve and/or adjacent components, wherein the vibration results from vibrating components in the vehicle, and in the case of automotive vehicles, movement of the vehicle over a ground surface. As such, it is customary to spirally wrap wires and wire harnesses with high temperature resistant foil tape and/or sound masking tape to reduce the potential for noise generation. Unfortunately, applying tape is labor intensive, and thus, costly. In addition, the appearance of the tape can be unsightly, particularly over time as the tape wears. Further, in service, tape can provide difficulties in readily accessing the wound wires.

Other than applying tape, it is known to incorporate heat and/or acoustic protection in the form of woven, braided or knitted fabric sleeves about the wires to reduce the potential for damage from heat and/or for noise generation. The respective sleeves are typically manufactured from heat resistant and noise suppressing materials, such as selected monofilament and texturized multifilament polyester yarns. The sleeves are either wrapped and fastened about the wires, or applied as a self wrapping sleeve construction. Further, it is known to provide non-woven sleeves having a non-woven layer and an outer reflective layer, wherein the sleeves are not self-wrappable, and are either wrapped and fastened about the wires with a secondary fastening device, or supplied as a tubular, non-wrappable sleeve. If wrapped and fastened, additional costs are incurred for the fasteners and in attaching the fasteners to the sleeves. Further, additional labor and/or processes are typically involved to secure the sleeves about the wires. In addition, the aforementioned sleeves are typically constructed of a uniform, homogenous construction, and thus, have a constant axial and radial stiffness/flexibility over their full length. As such, if the sleeve is constructed for extreme environments, thereby requiring a high degree of protection against heat and/or sound production, then the walls of the sleeves are constructed having an increased, thickness, and thus, the flexibility of the sleeve is diminished and the weight of the sleeve is increased. These are typically negative traits, particularly in applications requiring the sleeve to be routed around tight corners and having minimal weight. And thus, although these sleeves generally prove useful in providing protection against radiant heat and suppressing noise generation in use, they can be relatively costly to manufacture, with additional costs being incurred to attach fasteners to the sleeves and to secure the sleeves about the wires, and they can be relatively stiff and heavy.

A non-woven sleeve manufactured according to the present invention overcomes or greatly minimizes any limitations of the prior art described above, and also provides enhanced potential to withstand radiant heat and suppress noise generation by elongate members carried in the sleeves.

### SUMMARY OF THE INVENTION

One aspect of the invention provides a self-wrapping, non-woven thermal sleeve for routing and protecting elongate members from radiant heat and/or generating noise and vibration. The sleeve has an elongate, non-woven substrate with opposite sides that extend between opposite ends, with the opposite sides being self-wrapping about a central longitudinal axis to define a generally tubular cavity in which the elongate members are received. The opposite sides of the substrate are extendible away from one another under an externally applied force to allow the elongate members to be disposed radially into the cavity. Upon disposing the elongate members within the cavity, the external force is released, thereby allowing the opposite sides of the wall to return to their self-wrapped, tubular configuration. The substrate has a non-homogenous material composition providing first regions of a material and second regions of a material, wherein the material compositions of the first and second regions are different, thereby providing the first and second regions with different physical properties.

In accordance with another aspect of the invention, the first and second regions have a different stiffness.

In accordance with another aspect of the invention, the first and second regions have a different weight.

In accordance with another aspect of the invention, the first and second regions extend transversely to the central longitudinal axis and circumferentially about the sleeve to provide longitudinally spaced regions of enhance flexibility.

In accordance with another aspect of the invention, the first and second regions extend parallel to the central longitudinal axis between the opposite ends to provide the sleeve with strips of increased rigidity.

According to one aspect of the invention, the non-woven material forming the substrate of the sleeve includes different compositions of thermoplastic fibers therein. The different compositions of thermoplastic fibers are spaced from one another to provide the substrate with a non-homogeneous material composition and, when subjected to a heat treatment, take on a heat-set configuration, thereby biasing the substrate to a self-curled memory position.

According to another aspect of the invention, the thermoplastic fibers embedded or otherwise bonded to the non-woven material include low melt fibers mixed with standard thermoplastic fibers. The low melt fibers, when subjected to a heat treatment, take on a heat set configuration, thereby biasing the substrate to a self-curled memory position. The standard thermoplastic fibers act in part to provide the desired density and thickness to the substrate, as desired, thereby providing additional thermal protection and rigidity to the sleeve. The first region has a first wt % of low melt fibers and the second region has a second wt % of low melt fibers, wherein the first wt % is different from the second wt %. Accordingly, the substrate is constructed having first regions of one material composition and second regions of another material composition to provide the first and second regions with different physical properties, as desired.

According to another aspect of the invention, the non-woven substrate has an outer surface facing away from the central longitudinal axis and a reflective layer is attached to the outer surface.

According to another aspect of the invention, the reflective layer is provided as a foil laminate.

According to yet another aspect of the invention, the low melt fibers are encapsulated in the standard thermoplastic fibers.

According to yet another aspect of the invention, a lattice of thermoplastic material is bonded to a non-woven layer to form at least a portion of the sleeve wall.

According to yet another aspect of the invention, the lattice is a knit layer.

According to yet another aspect of the invention, the lattice is a monolithic piece of thermoplastic material.

According to yet another aspect of the invention, a method of constructing a non-woven sleeve for routing and protecting elongate members from radiant heat and/or generating noise and vibration is provided. The method includes: forming a wall of non-woven material; forming first regions in the wall from a first material; forming second regions in the wall from a second material different from the first material; and heat-setting the wall into the tubular configuration.

In accordance with another aspect of the invention, the method includes forming the first and second regions to extend transversely to the central longitudinal axis and circumferentially about the sleeve to provide longitudinally spaced regions of enhance flexibility.

In accordance with another aspect of the invention, the method includes forming the first and second regions to extend parallel to the central longitudinal axis between the opposite ends to provide the sleeve with strips of increased rigidity.

In accordance with another aspect of the invention, the method includes attaching a reflective layer to an outer surface of the wall.

In accordance with another aspect of the invention, the method includes embedding the first regions in the second regions in a needlefelting process.

In accordance with another aspect of the invention, the method includes forming one of the regions from a lattice of thermoplastic material.

In accordance with another aspect of the invention, the method includes forming the lattice as a knit layer of thermoplastic yarn filaments.

In accordance with another aspect of the invention, the method includes forming the lattice as an extruded monolithic piece of thermoplastic material.

### BRIEF DESCRIPTION OF THE DRAWINGS

These and other aspects, features and advantages of the invention will become readily apparent to those skilled in the art in view of the following detailed description of presently preferred embodiments and best mode, appended claims, and accompanying drawings, in which:

FIG. 1 is a schematic perspective view of a non-woven, self-wrapping thermal sleeve constructed in accordance with one aspect of the invention carrying and protecting elongate members therein;

FIG. 2 is an enlarged schematic partial perspective view taken generally along the line 2-2 of FIG. 1;

FIG. 2A is a view similar to FIG. 2 showing an outer reflective layer applied to the sleeve;

FIG. 3 is a schematic perspective view of a non-woven, self-wrapping thermal sleeve constructed in accordance with another aspect of the invention carrying and protecting elongate members therein;

FIG. 4 is an enlarged schematic partial perspective view taken generally along the line 4-4 of FIG. 3;

FIG. 4A is a view similar to FIG. 4 showing an outer reflective layer applied to the sleeve;

FIG. 5 is a schematic perspective view of a non-woven, self-wrapping thermal sleeve constructed in accordance with another aspect of the invention carrying and protecting elongate members therein;

FIG. 6 is an explode view of the wall of the sleeve of FIG. 5;

FIG. 6A is an exploded view of a wall constructed in accordance with another aspect of the invention;

FIG. 7 is a schematic perspective view of a non-woven, self-wrapping thermal sleeve constructed in accordance with yet another aspect of the invention carrying and protecting elongate members therein;

FIG. 8 is an explode view of the wall of the sleeve of FIG. 7; and

FIG. 8A is an exploded view of a wall constructed in accordance with another aspect of the invention.

### DETAILED DESCRIPTION OF PRESENTLY PREFERRED EMBODIMENTS

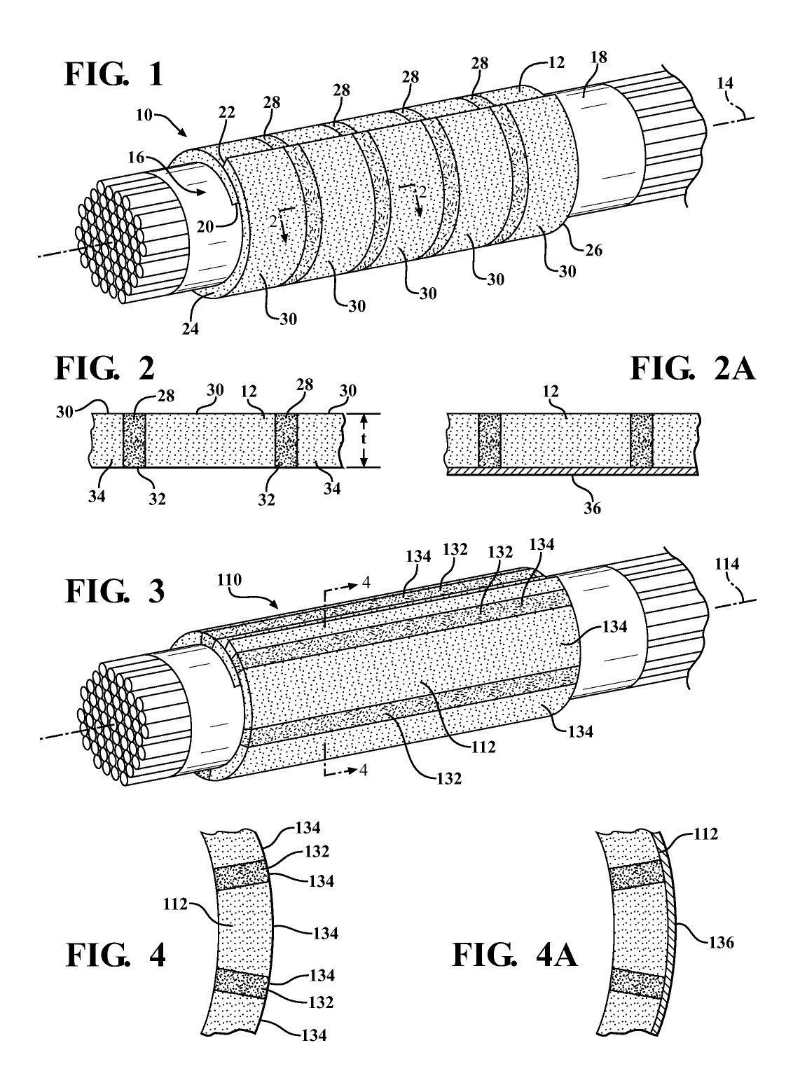

Referring in more detail to the drawings, FIG. 1 shows a non-woven, self-wrapping protective thermal sleeve, referred to hereafter as sleeve 10, constructed in accordance with one aspect of the invention. The sleeve 10 has a non-woven substrate layer, referred to hereafter as wall 12, constructed from an engineered non-woven material. The wall 12 is heat-set to take on a self-wrapping tubular “cigarette-style” configuration about a central longitudinal axis 14 to provide an enclosed tubular inner cavity 16 when the wall 12 is in a relaxed state, free of externally applied forces. The cavity 16 is readily accessible along the axis 16 so that elongate members, such as a pipe, wires or a wire harness 18, for example, can be readily disposed radially into the cavity 16, and conversely, removed from the cavity 16, such as during service. The wall 12 can be constructed of any suitable size, including length, diameter and wall thickness, wherein the wall 12 has opposite sides 20, 22 that extend parallel or substantially parallel to the axis 14 between opposite ends 24, 26. The opposite sides 20, 22 are self-wrapping about the central longitudinal axis 14 to provide the cavity 16 in which the elongate members are received. The opposite sides 20, 22 of the wall 12 are extendible away from one another under an externally applied force to allow the elongate members to be disposed radially into the cavity. Upon disposing the elongate members within the cavity, the external force is released, thereby allowing the opposite sides 20, 22 of the wall 12 to return to their self-wrapped, tubular configuration. The wall 12 has a non-homogenous (discontinuous) material composition across its width and/or length providing first regions 28 of one non-woven material composition and second regions 30 of another non-woven material composition, wherein the first and second regions 28, 30 are intertwined together in the nonwoven process. Accordingly, the material compositions of the first and second regions 28, 30 are different, thereby providing the first and second regions 28, 30 of the wall 12 with different physical properties. The different physical properties provide the wall 12, by way of example, with regions of enhanced longitudinal flexibility, enhanced curling bias, enhanced hoop stiffness, enhanced axial stiffness and reduced weight, depending on the physical properties desired for the intended application. Accordingly, the wall 12 has non-uniform physical properties, as desired, to provide the wall with, for example enhanced self-curling and reduced weight.

The sleeve 10 can be constructed having any desired length and various finished wall thicknesses (t). The non-woven material forming the wall 12, constructed in accordance with one aspect of the invention, as best shown in FIGS. 2 and 2A, has low melt fibers, including either monofilaments and/or bi-component fibers, represented generally at 32. The low melt fibers 32 can be mixed with standard thermoplastic fibers, represented generally at 34, if desired, otherwise, the low melt fibers 32 can constitute the first regions 28 entirely. The low melt 32 at least partially melt at a temperature lower than the standard thermoplastic fibers 34 when heat treated in a heat-setting process and take on a heat-set configuration, thereby biasing the wall 12 into a heat set shape, represented as a self-curled memory tubular shape. If bi-component fibers are provided as low melt fibers 32, they can be provided having a core of a standard thermoplastic material, such as polyethylene terephthalate (PET), for example, with an outer sheath of polypropylene, polyethylene, or low melt polyester, for example. The standard thermoplastic fibers 34 can be provided as any thermoplastic fiber, such as nylon or PET, for example, and act in part to provide the desired density and thickness (t) to the wall 12, as desired, thereby providing additional thermal protection and rigidity to the sleeve 10, while also being relatively inexpensive compared to the heat-settable fibers 32. Accordingly, the substrate 12 is constructed having a suitable thickness and density of mechanically intertwined, or otherwise bonded, non-woven standard thermoplastic fibers 32 and low melt fibers 34 configured in discrete locations relative to one another as needed to obtain the desired physical properties, depending on the application, while also being self-curled, at least initially and prior to use, into a tubular shape.

The type, quantity, size and ratio of the low melt fibers 32 and standard thermoplastic fibers 34 of the non-woven substrate 12 can be varied, and thus selected to provide the sleeve 10 with the desired stiffness, springback bias of the heat set curl, hand (softness), thermal heat resistance, and substrate density and overall thickness (t). As such, depending on the application, the sleeve 10 can be constructed having a relatively small outer diameter, while still providing the cavity 16 with sufficient volume to contain a predetermined lateral cross-sectional area of wires. If the application is more severe, wherein the sleeve is exposed to extreme heat and/or debris, then the thickness (t) of the wall 12 can be increased, as desired. In addition, increasing the wall thickness (t) typically provides the sleeve 10 with more rigidity, and thus, larger cavities 16 can be constructed while still providing the sleeve 10 with adequate rigidity and strength to contain increased numbers and diameters of wire.

In addition, beyond varying the type, quantity, size and ratio of the low melt fibers 32 and/or standard thermoplastic fibers 34, the disbursement (precise location) of the low melt fibers 32 and standard thermoplastic fibers 34 relative to one another is controlled to provide the sleeve 10 with the desired performance characteristics demanded by the application. By way of example and without limitation, as shown in FIGS. 1 and 2, the wall 12 has the first regions 28 formed of low melt fibers 32 disbursed in circumferentially extending bands spaced axially from one another along the length of the sleeve 10. Accordingly, the bands of low melt material 32, upon being heat-shaped, provide the sleeve 10 with its self-curling bias, while also providing increased hoop strength regions to enhance the crush strength of the sleeve 10. As mentioned, the circumferential bands of low melt material 32 can incorporate standard thermoplastic fibers 34 as well, thereby providing the discrete bands with a predetermined ratio of low melt fibers 32 to standard fibers 34, as desired. The circumferential bands of low melt material 32, along with standard fibers 34 if incorporated, are spaced from axially from one another by the second regions 30 formed purely of the standard thermoplastic fibers 34. As such, the standard thermoplastic fiber second regions 30 provide a material content that is less costly than the low melt first regions 28, while also providing the sleeve 10 with an overall reduced weight from a sleeve having low melt fibers uniformly throughout. With the circumferentially extending low melt first regions 28 and standard thermoplastic fiber second regions 30 alternating with one another, the sleeve 10 is provided enhance longitudinal flex points coinciding with the standard thermoplastic fiber second regions 30. As such, depending on the application requirements, the second regions 30 of standard fiber 34 can be provided having any desired axial length to provide the sleeve 10 with the necessary flexibility.

In addition to varying the content of low melt fibers 32 versus standard thermoplastic fibers 34, the type and content of the low melt fibers 32 can be varied throughout the wall 12, as desired, thereby changing the physical properties of the sleeve 10. For example, the low melt bi-component fibers can be provided having different material compositions in different regions of the sleeve 10. In one region of the sleeve 10, the low melt bi-component fibers 32 can have a reduced relative percentage of low melt outer sheath material and an increased relative percentage of standard thermoplastic fiber core material, e.g., 10% sheath and 90% core, while in another region of the sleeve 10 the bi-component fibers 32 can have an increased relative percentage of low melt outer sheath material and a decreased relative percentage of standard thermoplastic fiber core material, e.g., 30% sheath and 70% core. Further yet, the size, i.e. staple length and diameter or denier, of the low melt fibers 32 can be varied to provide the sleeve 10 with the desired physical properties over its length. For example, in one region, the low melt fibers 32 could have a staple length of 2″ and a 4 denier, while in another region, the low melt fibers 32 could have a staple length of 3″ and a 10 denier. Further yet, the ratio of the low melt fibers 32 relative to the standard thermoplastic fibers 34 within each of the aforementioned regions can be different. By changing the specification of the low melt fibers 32 from one region of the sleeve 10 to another region, the sleeve 10 can attain an optimal self-curling memory, flexibility and stiffness, while also being economical in manufacture.

According to a further aspect of the invention, the aforementioned physical properties of the sleeve 10 can be provided by controlling the orientation of the fibers 32 within the wall 12 of the sleeve 10. For example, the fibers 32 can be combed or otherwise oriented in manufacture of the wall 12 to extend the fibers 32 in a predetermined, strategic pattern. For example, to enhance the longitudinal stiffness of the sleeve 10, the fibers 32 can be configured to extend along the axis 14 in a lengthwise direction of the sleeve 10. In contrast, if enhanced hoop strength is desired, the fibers 32 can be configured to extend transversely to the axis 14 in a widthwise (weft) direction of the sleeve 10, which in turn, could provide discrete flex locations along the length of the sleeve 10, while also providing the sleeve 10 with enhanced roundness, anti-kinking ability and improved self-curling memory. Of course, depending on the application, a single sleeve constructed in accordance with the invention could have separate axially extending portions, including one or more axial portions with the fibers 32 extending in one direction and one or more axial portions with the fibers 32 extending in a different direction. Accordingly, a single sleeve 10 can be provided having different physical properties over discrete axially extending portions, as desired.

As shown in FIGS. 3 and 4, a sleeve 110 constructed in accordance with another aspect of the invention is shown, wherein the same reference numerals, offset by a factor of 100, are used to identify similar features described above. Rather than the sleeve 110 having a wall 112 with circumferentially extending bands of low melt fibers 132, the wall 112 has longitudinally extending first regions 128 of bands, also referred to as strips, of low melt fibers 132 and longitudinally extending second regions 130 of bands, also referred to as strips, of standard thermoplastic material, e.g. PET. The low melt fibers 132 can be combined with standard thermoplastic fibers 134 in the strips of first regions 128, as discussed above, to provide the desired ratio and composition necessary to provide the sleeve 110 with the sought after physical properties. By having the strips extend along the length of the sleeve 110 generally parallel to a longitudinal, central axis 114, the sleeve 110 is provided with an increased longitudinal rigidity. As such, the sleeve 110 is less inclined to sag over unsupported portions of its length. The axially extending strips containing the low melt fibers 132 are circumferentially spaced from one another by the axially extending strips of the second regions 130 formed entirely of standard thermoplastic fibers 134, thereby reducing the weight and manufacturing cost of the sleeve 110 in comparison to a sleeve constructed entirely of low melt and/or bicomponent fibers. Other than the direction of the strips extending parallel to the longitudinal axis 114, the structure and manufacture of the sleeve 110 is generally the same as discussed above.

In FIGS. 2A and 4A, another aspect of the invention is shown wherein an outermost reflective layer 36, 136 can be attached to the wall 12, 112 of the sleeve 10, 112, respectively. The reflective layer 36, 136 can be provided having the same width and length as the wall 12, 112 and thus, can cover or substantially cover the entire outer surface of the wall 12, 112, thereby leaving no exposed areas of the wall outer surface to the outside environment. The reflective layer 36, 136 can be provided as a film/foil laminate, such as ⅓ mil foil-laminating adhesive-½ mil metallized PET film, for example. As such, the foil provides reflectivity and the PET film provides durability in use. Otherwise, other reflective materials could be used, including a single metal foil layer, for example. The reflective layer 36, 136 can be attached to the wall 12, 112 in any suitable fashion, such as by any suitable adhesive, including heatseals or an intermediate pressure sensitive adhesive, for example. The reflective layer 36, 136 provides enhanced thermal protection to the wires 18 and can also facilitate maintaining the sleeve 10, 110 in its wrapped tubular configuration about the wires 18 in use.

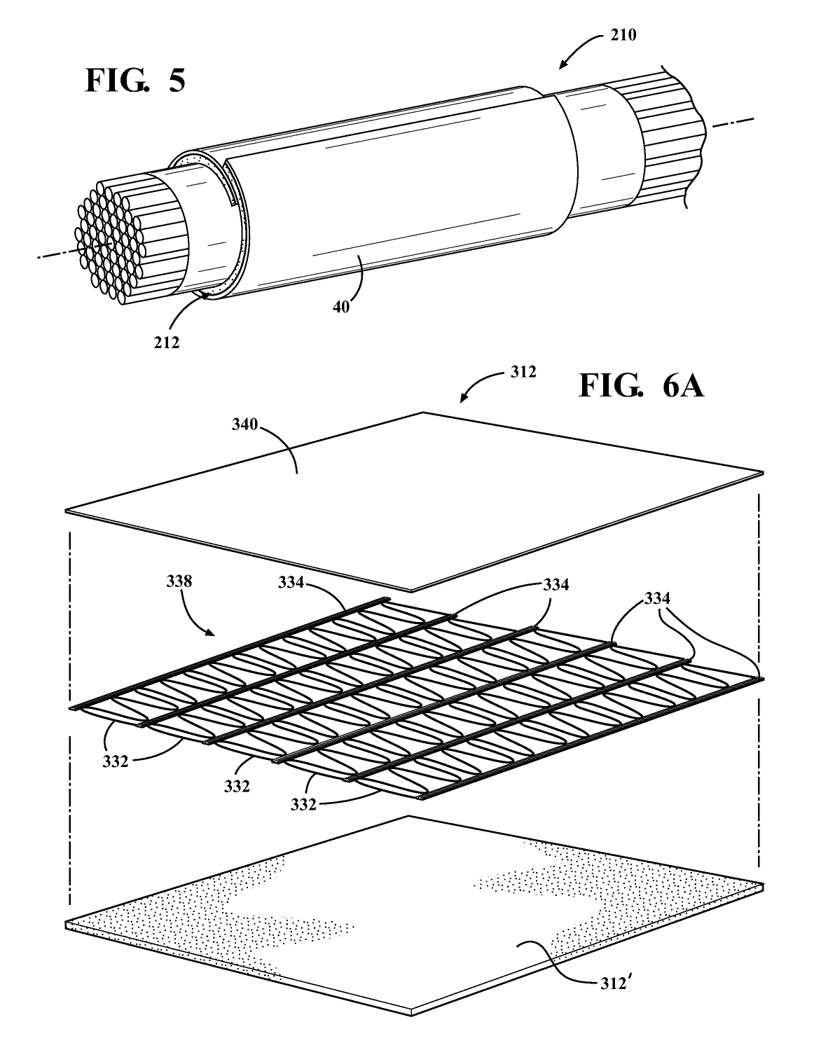

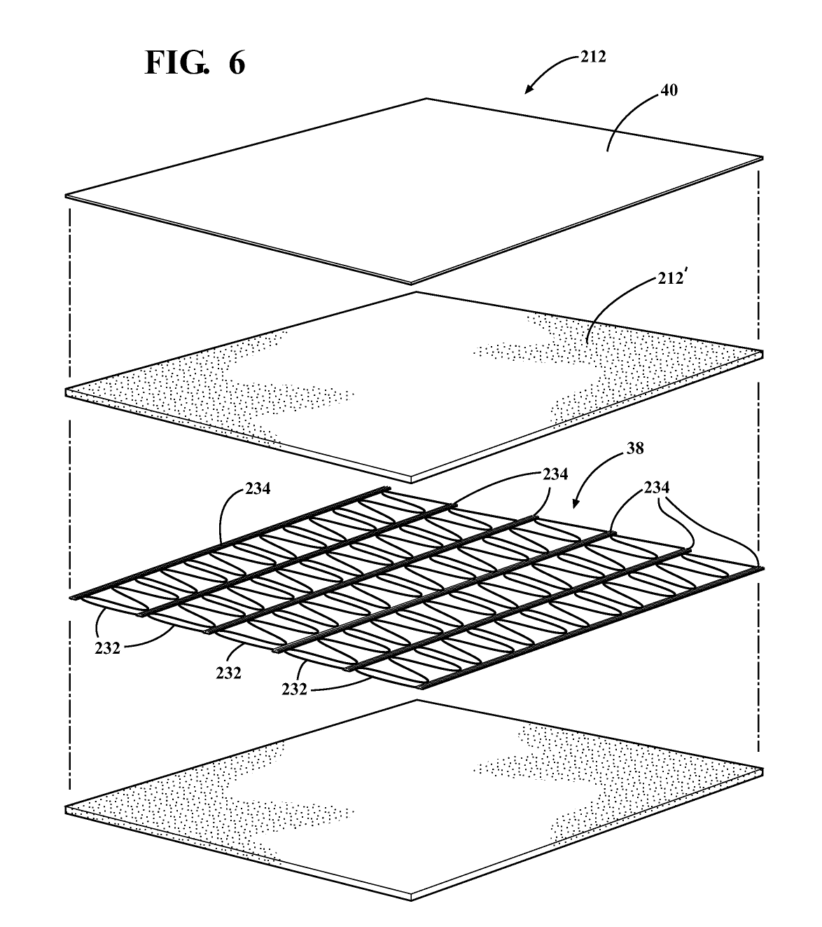

According to a further aspect of the invention, as shown in FIGS. 5 and 6, by way of example and without limitation, the aforementioned differing physical properties of a sleeve 210 can be provided by constructing a pair of a non-woven layers 212′, such as in an airlaying process, for example, and a lattice network having first and second regions 228, 230 different physical properties of standard thermoplastic fibers 234 and/or low melt fibers 232, which can include bi-component fibers as discussed above (referred to hereafter simply as lattice 38) can be sandwiched between the non-woven layers 212′. The lattice 38 can be sandwiched and at least partially embedded within the layers 212′ via a mechanical needling process. During construction, the lattice 38 is sandwiched between the non-woven layers 212′ and then the layers 212′ are needled to intertwine fibers of the separate layers 212′ with one another, thereby forming a unitized non-woven wall 212 structure including the captured lattice 38. The lattice 38 can be formed having any suitable geometric configuration, combination and types of the standard thermoplastic fibers 234 and/or low melt fibers 232, as desired, to form the non-woven wall 212 having the first and second regions 128, 130 of differing propensity to retain a curled heat-set, flexibility and stiffness. In accordance with one presently preferred embodiment, the lattice 38 is constructed as a warp knit structure using the desired material, type of yarn (e.g., monofilament and/or multifilament), size, and orientation of yarns (e.g., picks per inch, warp density), for example. Other than being constructed in a knitting process, it is contemplated that braiding, weaving, machining, die cutting, rapid prototyping, and the like, can be used to manufacture a lattice in accordance with the invention. Further, the lattice 38 can be constructed having any suitable thickness or thickness variation, as desired for the intended application. Accordingly, the direction and size of the alternating flexible regions versus stiff regions formed in the wall 212 can be controlled depending on the application requirements. It should be recognized that to facilitate needling, the knit pattern of the lattice 38 can be formed providing the desired openings between adjacent yarn filaments to prevent the filaments 332 from being caught by the needles during the needling process.

Upon capturing the lattice 38 within the wall 212, the wall 212 can have a reflective layer 40 attached thereto. The reflective layer 40 can be provided in any suitable form, such as a thin layer of foil or metalized film, for example. The reflective layer 40 can be adhered via any suitable adhesive to the outer surfaces of the non-woven layers 212′, shown here as being adhered to the outer surface on one non-woven layer 212′ corresponding what will an outer surface of the sleeve 210. Upon adhering the reflective layer 40 to the wall 212, the wall 212 can be curled into its desired shape, and then heated to cause heat-settable yarns within the lattice 38 to take on a heat-set, curled configuration to bias the wall 212 into a self-curling configuration. This could be done via a heated mandrel, ultrasonic welding, or otherwise, as desired. As shown, by way of example, the lattice 38 has warp-wise (extending along the length of the sleeve 210) extending thermoplastic multifilaments 234, such as PET, by way of example, interlaced with weft-wise extending low-melt monofilaments 232, wherein separate weft-wise extending low-melt monofilaments 232 are knit between adjacent multifilaments and sinusoidal fashion to form the monolithic lattice 38 structure.

In accordance with another aspect of the invention, as shown in FIG. 6A, rather than having the a wall with a pair of non-woven layers overlying opposite sides of an intermediate lattice, as shown in FIG. 6, a wall 312 can be constructed in a lamination process having a single non-woven layer 312′ and a reflective layer 340 overlying opposite sides of an intermediate lattice 338. For example, the lattice 338, which is constructed the same as discussed above, is laid over one of the layers 312′ and the other layer 340 is placed over the lattice 338, whereupon heat is applied to the lattice 340 to cause thermoplastic filaments 332, 334 within the lattice 338 to at least partially melt. As such, the melted filaments 332, 334 act as glue and cause the sandwiched layers 312′, 340 and intermediate lattice 338 to be bonded together to form the unitized wall 312. In order to create a self-curling sleeve configuration with the wall 312, prior to heating the lattice 338, the wall 312 can be first shaped into a curled configuration, and then heated. In one presently preferred method of heating the fibers, an ultrasonic welding process is used to at least partially melt some of the filaments of the lattice 338 to bond the layers 312′, 340 to one another. Of course, any suitable method of heating the heat-settable filaments of the lattice 338 can be used. In addition, the layers 312′, 340 can be bonded together via an adhesive applied therebetween, or, the layer 312′ and the lattice 338 can be needled to mechanically lock the layer 312′ to the lattice 338. Then, the reflective layer 340 can be attached and the lattice 338 via an adhesive, whereupon the wall 312 can be heat-set to attain its self-curling configuration.

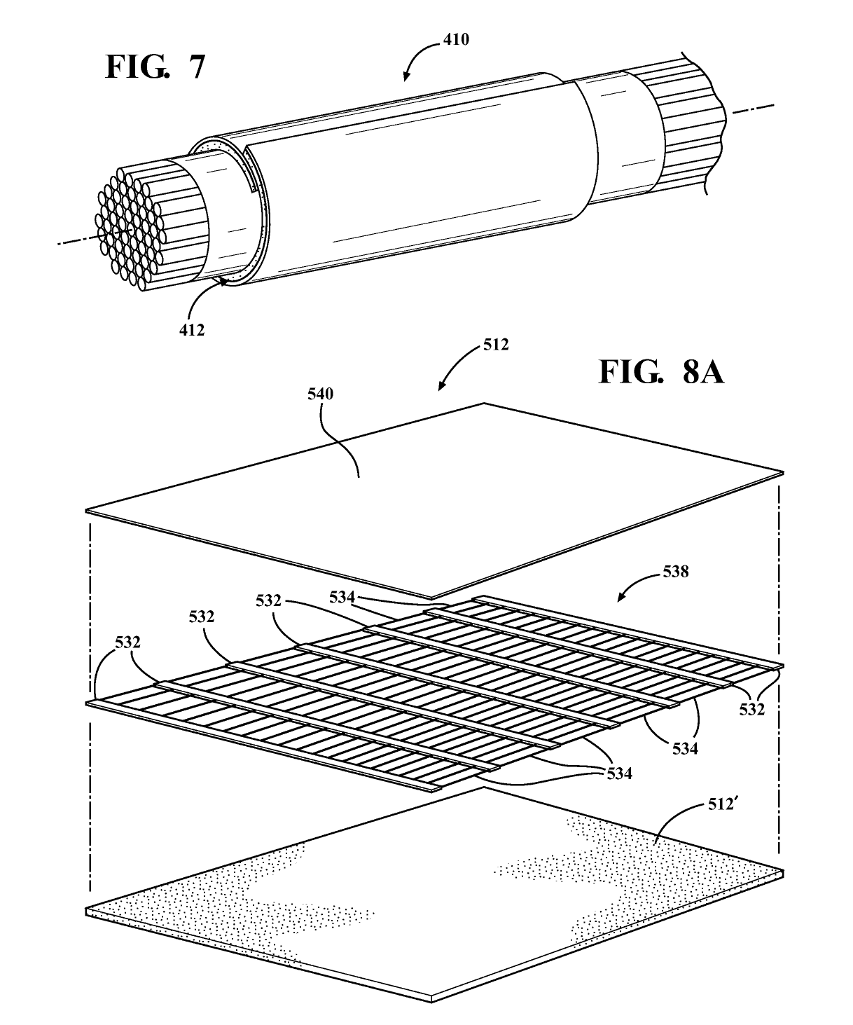

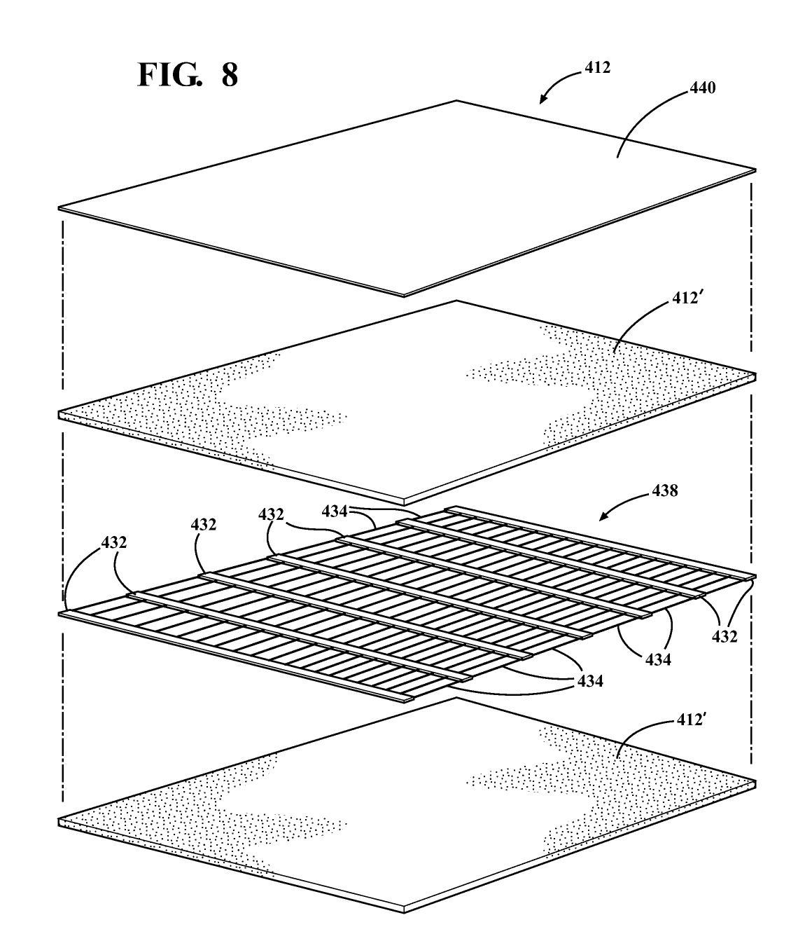

According to a further aspect of the invention, as shown in FIGS. 7 and 8, by way of example and without limitation, the aforementioned physical properties of a sleeve 410 can be provided by constructing a pair of a non-woven layers 412′, such as in an airlaying process, for example, and a monolithic lattice network of standard thermoplastic material 434 and/or low melt material 432, which can include bi-component fibers as discussed above (referred to hereafter simply as lattice 438) can be sandwiched between the non-woven layers 412′. The lattice 438, if formed as a single composition of material, can be extruded. The lattice 438 is formed having first and second regions 428, 430 of differing physical properties, and, by way of example, has warp-wise (extending along the length of the sleeve 410) extending thermoplastic ribs 434 and weft-wise extending thermoplastic ribs 432 interconnected as a single piece of material with one another. The weft-wise extending ribs 432 are shown as being axially spaced equidistantly from one another to provide discrete, flexible regions therebetween. Further, the weft-wise ribs 432 are provided having an increased cross-section area relative to the warp-wise extending ribs 434, such as via an increased thickness or diameter, to provide enhanced curl memory upon being heat-set. The relatively reduced thickness or width warp-wise ribs 434 provide the sleeve 410 with enhanced flexibility and tensile strength, while at the same time minimize the cost and weight of the sleeve 410. It should be recognized that the type of material used to form the monolithic lattice 438 can be provided as desired for the intended application, such as a standard thermoplastic material, e.g. PET, or a low-melt material, e.g. polypropylene, polyethylene, or low melt polyester, for example, or as a bi-component material, as discussed above.

Upon laminating the lattice 438 in sandwiched relation within the wall 412, the wall 412 can have a reflective layer 440 attached thereto. The reflective layer 440 can be provided in any suitable form, such as a thin layer of foil, metalized film or otherwise, as discussed above. The reflective layer 440 can be adhered via any suitable adhesive to the outer surfaces of the non-woven layers 412′, shown here as being adhered to the outer surface on one non-woven layer 412′ corresponding what will an outer surface of the sleeve 410. Upon adhering the reflective layer 440 to the wall 412, the wall 412 can be curled into its desired shape, and then heated to cause heat-settable lattice 438 to take on a heat-set, curled configuration to bias the wall 412 into a self-curling configuration. This can be done as described above for the sleeve 310.

In accordance with another aspect of the invention, as shown in FIG. 8A, a wall 512 can be constructed having a single non-woven layer 512′ and a reflective layer 540 overlying opposite sides of an intermediate lattice 538, wherein the non-woven layer 512′ and lattice 538 are constructed the same as described above regarding the non-woven layer 412′ and lattice 438. For example, the lattice 538 is laid over one of the layers 512′ and the other layer 540 is placed over the lattice 538, whereupon heat is applied to the lattice 540 to cause thermoplastic filaments 532, 534 within the lattice 438 to at least partially melt and act as glue to cause the sandwiched layers 512′, 540 to be bonded together to form the unitized wall 512. As discussed above, in order to create a self-curling sleeve configuration with the wall 512, the wall 512 can be first shaped into a curled configuration, and then heated. In addition, the layers 512′, 540 can be bonded together via an adhesive applied therebetween, or, the layer 512′ and the lattice 538 can be needled to mechanically lock them to one another, whereupon the reflective layer 540 can be attached to the lattice 538 and the wall 512 heat-set to attain the self-curling configuration, as discussed above.

It is to be understood that other embodiments of the invention which accomplish the same function are incorporated herein within the scope of any ultimately allowed patent claims.

What is claimed is:

1. A self-wrapping, non-woven sleeve for routing and protecting elongate members, comprising:
an elongate non-woven wall having opposite sides extending along a longitudinal axis of said sleeve, said sides being self-wrapped about said longitudinal axis to provide a tubular cavity in absence of an externally applied force, said sides being extendable away from one another under an externally applied force to expose said cavity for insertion of the elongate members, said sides returning to their self-wrapped configuration upon removal of the externally applied force; and
said wall having discrete first regions of a material and discrete second regions of a material, said first and second regions of material being different and providing said wall with non-uniform physical properties.

2. The sleeve of claim 1 wherein said wall has at least one non-woven layer and a lattice of heat-settable polymeric material attached to said at least one non-woven layer.

3. The sleeve of claim 2 wherein said lattice is a monolithic piece of material.

4. The sleeve of claim 3 wherein said lattice includes warp-wise ribs extending substantially parallel to said longitudinal axis and weft-wise ribs extending substantially transversely to said longitudinal axis.

5. The sleeve of claim 4 wherein said weft-wise ribs have an increased cross-sectional area relative to said warp-wise extending ribs.

6. The sleeve of claim 3 wherein said lattice includes a low-melt material.

7. The sleeve of claim 2 wherein said wall has a pair of non-woven layers attached to opposite sides of said lattice.

8. The sleeve of claim 7 further including a reflective layer attached to one of said non-woven layers, said reflective layer forming an outer surface of said sleeve.

9. The sleeve of claim 2 further including a reflective layer attached to said lattice.

10. The sleeve of claim 2 wherein said lattice is a knit layer.

11. The sleeve of claim 10 wherein said knit layer has warp-wise filament yarns extending substantially parallel to said longitudinal axis and weft-wise filament yarns extending substantially transversely to said longitudinal axis, said warp-wise filament yarns being a different material than said weft-wise extending yarns.

12. The sleeve of claim 11 wherein said warp-wise extending yarns are PET.

13. The sleeve of claim 12 wherein said weft-wise extending yarns are a low-melt material.

14. The sleeve of claim 11 wherein said warp-wise extending yarns are multifilaments.

15. The sleeve of claim 14 wherein said warp-wise extending yarns are monofilaments.

16. The sleeve of claim 11 wherein said warp-wise extending yarns are monofilaments.

17. The sleeve of claim 1 wherein said first regions of material include low-melt fibers blended in said non-woven wall and said second regions include standard thermoplastic fibers blended in said non-woven wall.

18. The sleeve of claim 17 wherein said first regions form discrete bands spaced axially from one another, said bands extending substantially transversely to said longitudinal axis.

19. The sleeve of claim 17 wherein said low-melt fibers are polypropylene.

20. The sleeve of claim 19 wherein said standard thermoplastic fibers are PET.

21. The sleeve of claim 17 wherein said first regions form discrete bands spaced circumferentially from one another, said bands extending substantially parallel to said longitudinal axis.

22. A method of constructing a non-woven sleeve for routing and protecting elongate members from radiant heat and/or generating noise and vibration, comprising:
forming a wall of non-woven material;
forming first regions in the wall from a first material;
forming second regions in the wall from a second material different from the first material; and
heat-setting the wall into the tubular configuration.

23. The method of claim 22 further including forming the wall having at least one non-woven layer and attaching a lattice of heat-settable polymeric material to the at least one non-woven layer.

24. The method of claim 23 further including providing the lattice as a monolithic piece of material.

25. The method of claim 24 further including providing the lattice having warp-wise ribs extending substantially parallel to the longitudinal axis and weft-wise ribs extending substantially transversely to the longitudinal axis.

26. The method of claim 25 further including providing the weft-wise extending ribs with an increased cross-sectional area relative to the warp-wise extending ribs.

27. The method of claim 23 further including forming the wall having a pair of non-woven layers and attaching the non-woven layers to opposite sides of the lattice.

28. The method of claim 27 further including attaching the pair of non-woven layers to the lattice in a needling process.

28. The method of claim 27 further attaching a reflective layer to one of the non-woven layers to form a reflective outer surface on the sleeve.

29. The method of claim 23 further including attaching a reflective layer to the lattice.

30. The method of claim 23 further including needling the at least one non-woven layer to the lattice.

31. The method of claim 23 further including at least partially melting the lattice to bond the lattice to the at least one non-woven layer.

32. The method of claim 31 further including performing the heat-setting and the melting in the same process.

33. The method of claim 23 further including forming the lattice as a knit layer.

34. The method of claim 33 further including knitting the knit layer having warp-wise filament yarns of one material extending substantially parallel to the longitudinal axis and weft-wise filament yarns of a different material extending substantially transversely to the longitudinal axis.

35. The method of claim 34 further including providing the warp-wise extending yarns as PET.

36. The sleeve of claim 35 further including providing the weft-wise extending yarns as a low-melt material.

37. The method of claim 34 further including providing the warp-wise extending yarns as multifilaments.

38. The method of claim 37 further including providing the warp-wise extending yarns as monofilaments.

39. The method of claim 34 further including providing the warp-wise extending yarns as monofilaments.

40. The method of claim 22 further including forming the first regions by blending low-melt fibers in the non-woven wall and forming the second regions by blending standard thermoplastic fibers in the non-woven wall.

41. The method of claim 40 further including forming the first regions as discrete bands spaced axially from one another and extending substantially transversely to the longitudinal axis.

42. The method of claim 40 further including providing the low-melt fibers as polypropylene.

43. The method of claim 42 further including providing the standard thermoplastic fibers as PET.

44. The method of claim 40 further including forming the first regions as discrete bands spaced circumferentially from one another and extending substantially parallel to the longitudinal axis.
